(19) United States
(12) Patent Application Publication
(10) Pub. No.: US 2013/0191263 A1
(43) Pub. Date: Jul. 25, 2013

(54) TRADING SYSTEM AND TRADING METHOD

(71) Applicant: Tatsuya NAKAE, Los Gatos, CA (US)

(72) Inventor: Tatsuya NAKAE, Los Gatos, CA (US)

(73) Assignee: HITACHI, LTD., Tokyo (JP)

(21) Appl. No.: 13/356,008

(22) Filed: Jan. 23, 2012

(51) Int. Cl. G06Q 40/04

(52) U.S. Cl. 705/37

(57) ABSTRACT

A trading computer system with a function of enabling faster trading based on real-time analysis of rich media such as video stream and voice stream. Another object of the present invention is to provide a trading computer system with a function of enabling avoiding excessive order execution while keeping low latency when there are plural rich media news data related to the same event in plural media data centers.

### TECHNICAL FIELD

The present invention relates to a trading system and a trading method.

### BACKGROUND ART

In financial trading markets High Frequency Trading (HFT) has been expanding more and more. HFT technology enables broker-dealers to execute orders in milliseconds based on automatic real-time risk analysis using not only market data i.e. latest Bid, Ask, and agreed price of financial instruments delivered by exchanges, but also rich media data delivered by news feeders in the formats of XML, text, voice, and videos. When the HFT platform such as complex event processing (CEP) engine receives plural news regarding one event e.g. a press interview by the Prime Minister, it clusters or duplicates those news in order to avoid excessive order execution.

The techniques related to HFT, CEP or information duplication which are disclosed, for example, in PTL 1, PTL 2, and PTL 3 are proposed. PTL 1 relates to, for example, systems and methods for transmitting trade orders from a client trading engine to an exchange system. In order to achieve low latency trading, the low latency system described in PTL 1 performs one or a limited number of pre-order risk checks, and the post-order risk checking data center performs risk checks on the trade orders after the low latency system transmits the trade orders to the exchange server(s).

PTL 2 relates to a method and system for providing real-time electronic information for risk assessment and management for multi-market electronic trading. It separates one or more data streams with plural different types of electronic trading information into plural separate data streams that may be selectively used by dealers in order to let the plural separate data be streamed, displayed and used fast and efficiently.

PTL 3 relates to a method for collecting information from web pages and eliminating duplicate information. It eliminates duplicates after collecting various web pages.

### CITATION LIST

### Patent Literature

[PTL 1] US Pub. No.: US2010/0094743A1
[PTL 2] U.S. Pat. No. 7,912,781B2
[PTL 3] U.S. Pat. No. 7,836,009B2

### SUMMARY OF INVENTION

### Technical Problem

However, PTL 1 does not disclose a technique for high-speed order execution based on real-time analysis of rich media (i.e. video streams or voice streams) of news.

The methods and systems disclosed in PTL 2 are not suitable for video streams and voice streams because each video stream and voice stream does not include plural different types of information which may be used individually for trading. Accordingly PTL 2 is not helpful in high speed processing of video and voice streams for high frequency trading.

The methods disclosed in PTL 3 are difficult to apply to deduplicating rich media for high frequency trading because it takes much time to gather large-size rich media data from news sources such as mass media data centers into deduplication system located near an exchange venue via wide area network.

### Solution to Problem

The present invention has been made in order to solve the above and other problems, and an object thereof is to provide a trading computer system with a function of enabling faster trading based on real-time analysis of rich media such as video stream and voice stream. Another object of the present invention is to provide a trading computer system with a function of enabling avoiding excessive order execution while keeping low latency when there are plural rich media news data related to the same event in plural media data centers.

### Advantageous Effects of Invention

According to one aspect of the present invention, a trading system with a function of enabling faster trading based on real-time analysis of rich media such as video stream and voice stream and a controlling method of the same are provided.

According to another aspect of the present invention, a trading system with a function of enabling avoiding excessive order execution while maintaining high velocity when there are plural rich media news data related to the same event in one ore more media data centers and a controlling method of the same are provided.

### BRIEF DESCRIPTION OF DRAWINGS

FIG. 1 is a figure showing a connection construction and a software construction of a trading system 100.

FIG. 2 is a figure showing an example of a construction of a computer 200.

FIG. 3 is a flow diagram showing a method for trading using rich media analysis.

FIG. 4 is a flow diagram showing a method for trading using rich media analysis.

FIG. 5 is a flow diagram showing a method for determining an event ID.

FIG. 6 is a flow diagram showing a method for determining an event ID.

FIG. 7 is a flow diagram showing a method for order execution.

FIG. 8-A shows composition of the event ID management table 116.

FIG. 8-B shows composition of the media classification table 124.

FIG. 8-C shows composition of the analysis management table 125.

FIG. 9 is a figure showing a connection construction and a software construction of a trading system 900.

FIG. 10 is a flow diagram showing a method for trading using rich media analysis.

FIG. 11 is a flow diagram showing a method for determining an event ID.

FIG. 12 is a flow diagram showing a method for determining an event ID.

FIG. 13-A shows composition of the permission management table 916.

FIG. 13-B shows composition of the media classification table 923.

FIG. 14 is a flow diagram showing a method for analyzing media data.

FIG. 15 shows an example of tag/value sets generated as a result of a media data analysis.

FIG. 16 is a flow diagram showing a method for a risk analysis.

FIG. 17 shows composition of the scenario table 126.

FIG. 18 shows composition of the weight definition 128.

### DESCRIPTION OF EMBODIMENTS

### Example 1

The embodiments will be described hereinbelow, as referring to the appended drawings. It is to be noted that the functions of various programs to be mentioned below are realized by a CPU or a processor which reads the programs from memory and executes the same as referring to information stored in various management tables.

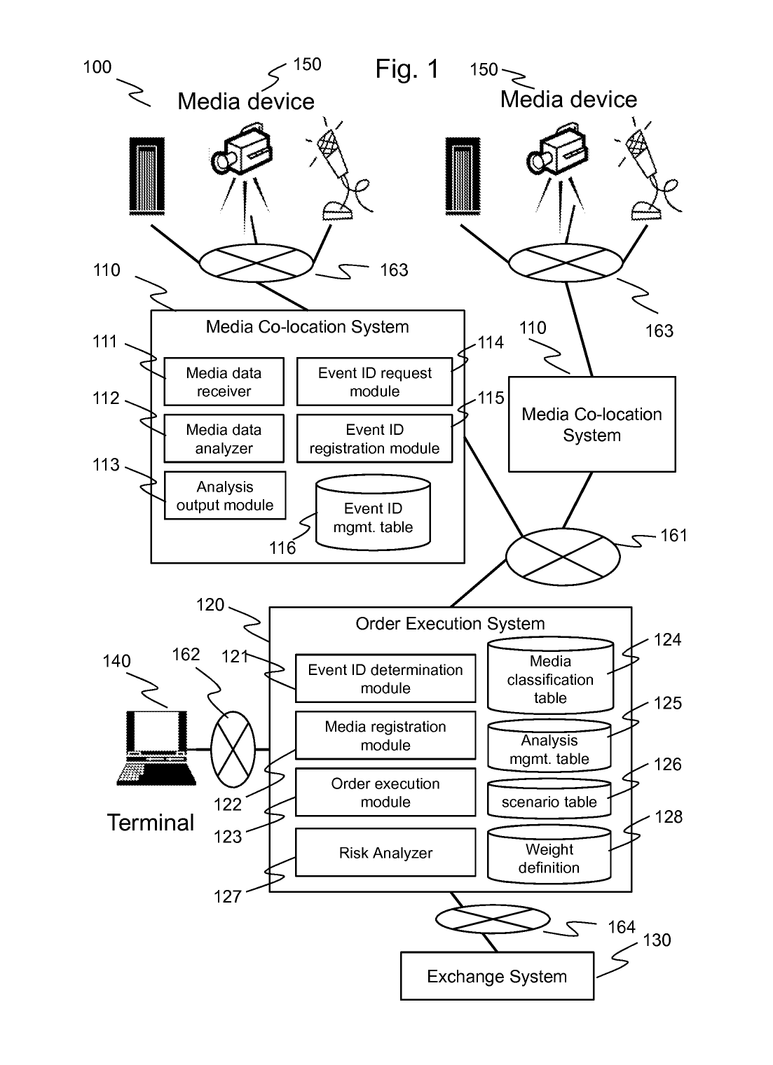

FIG. 1 shows an example of a connection configuration of the trading system 100. The trading system 100 includes at least one media co-location system 110, an order execution system 120, an exchange system 130, at least one terminal computer, hereinafter “terminal” 140, at least one media device 150. The media co-location system 110 and the order execution system 120 are coupled with a first communication network 161, which is for example a WAN (Wide Area Network), communicatively to each other.

The order execution system 120 and the terminal 140 are coupled with a second communication network 162, which is for example a LAN (Local Area Network), communicatively to each other. The media co-location system 110 and the media device 150 are coupled with a third communication network 163, which is for example a LAN (Local Area Network), communicatively to each other.

The order execution system 120 and the exchange system 130 are coupled with a forth communication network 164, which is for example a LAN (Local Area Network), communicatively to each other. The media co-location system 110 includes a media data receiver 111, a media data analyzer 112, an analysis output module 113, an event ID request module 114, an event ID registration module 115, and one or more storage areas for storing an event ID management table 116.

The order execution system 120 includes an event ID determination module 121, a media registration module 122, an order execution module 123, a risk analyzer 127 and one or more storage areas for storing a media classification table 124, an analysis management table 125, a scenario table 126, and a storage weight definition information 128.

The exchange system 130 is a trading platform which receives Bid orders and Ask orders from the order execution system 120 and matches Bid and Ask orders. The exchange system 130 is owned by, for example, a stock exchange, a commodity exchange, or a futures exchange. The media device 150 is one or more devices that may send video data or voice data or both of them, such as a microphone, a video camera or a media data server.

The media device 150 and the media co-location system 110 are located geographically close to each other so that rich media data may be transferred from the media device 150 to the media co-location system 110 with low latency. Some media devices are possibly located geographically apart from each other when they are owned by different news companies. In such a case, plural media co-location systems are implemented corresponding to the location of media devices.

The order execution system 120 and the exchange system 130 are located geographically close to each other so that ordering data may be exchanged with low latency. Then, a hardware configuration of the media co-location system 110 and the order execution system 120 will be described.

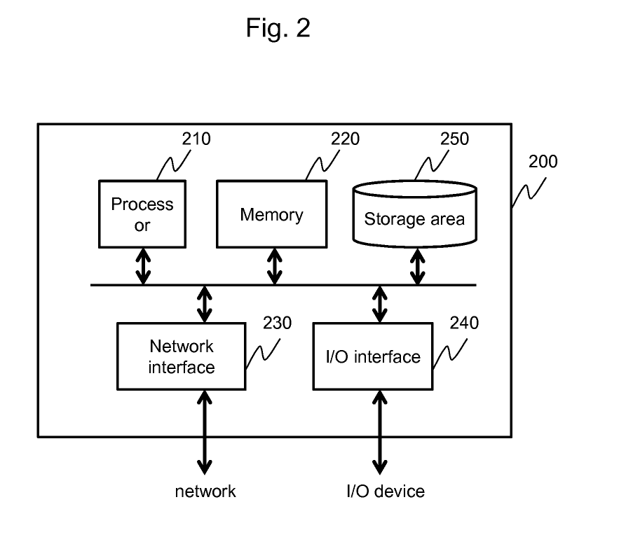

FIG. 2 shows an exemplary construction of a computer 200 which may be used as the media co-location system 110 or the order execution system 120. The computer 200 includes a processor 210 such as a CPU (Central Processing Unit), MPU (Micro Processing Unit), or the like, a memory 220, a network interface 230, an I/O interface 240 and one or more storage areas 250.

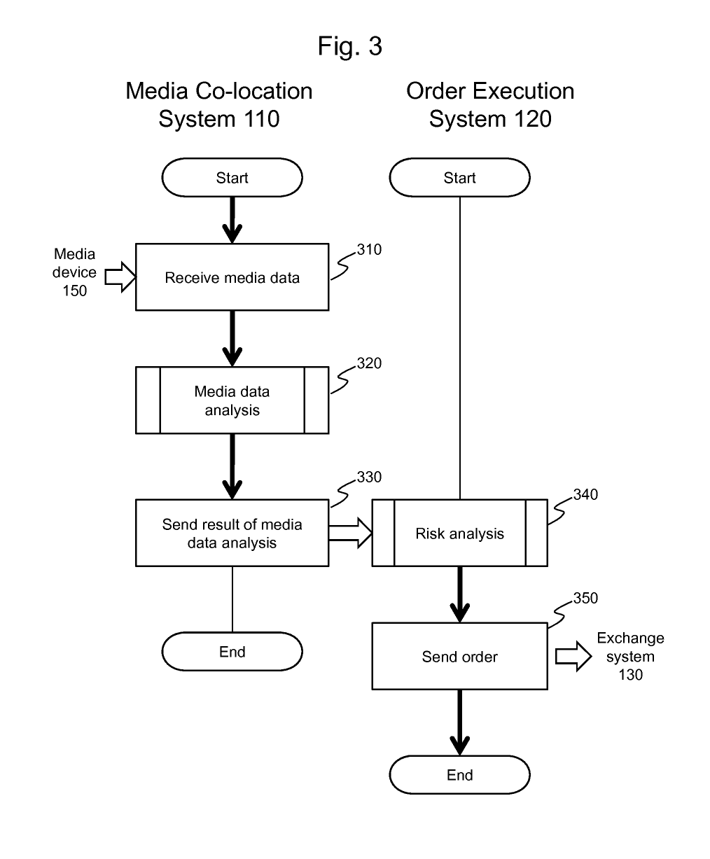

FIG. 3 is a flow diagram showing a method for order execution using rich media analysis. At step 310, the media data receiver 111 in the media co-location system 110 receives media data from the media device 150. At step 320, the media data is analyzed by the media data analyzer 112 and a result of the media data analysis, which is for example who is speaking, what he/she is speaking, is derived. At step 330, the result of the media data analysis is sent by the analysis output module 113 to the order execution system 120 via the first communication network 161.

At step 340, based on the result of the media data analysis, a risk analysis is conducted and results of the risk analysis, which is for example which financial instruments are influenced by the speech, and how strong the influence is, are derived by a risk analyzer 127. At step 350, Bid and/or Ask orders are sent to the exchange system 130.

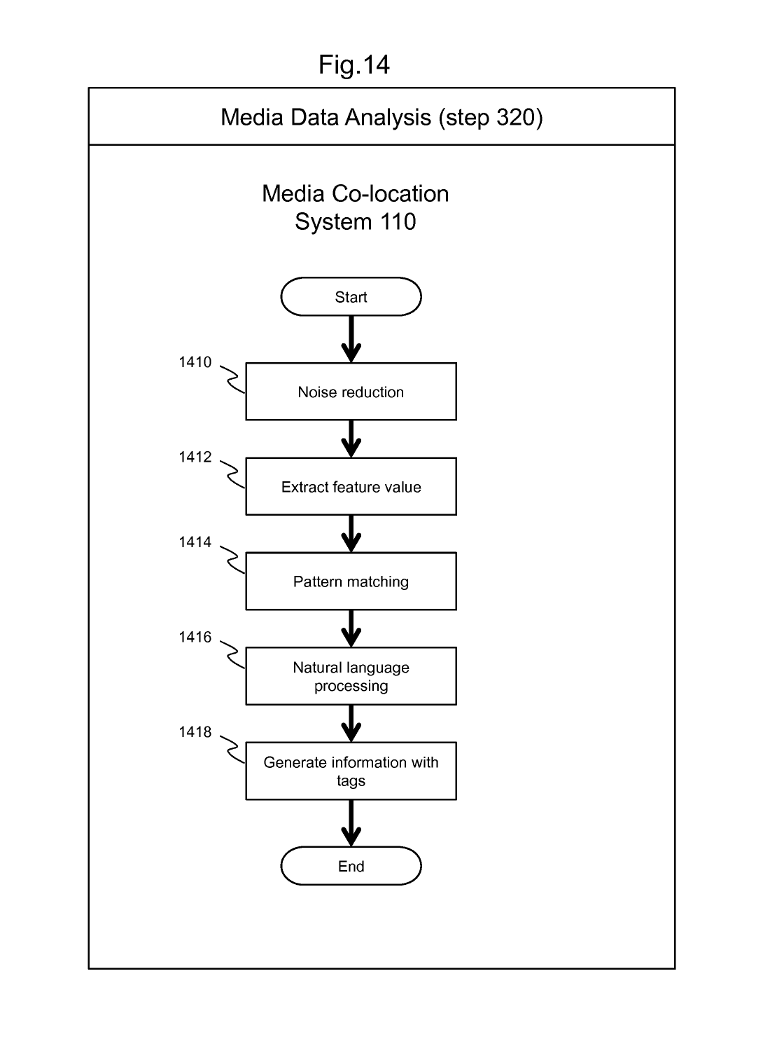

FIG. 14 is a flow diagram showing an example of details of the media data analysis (step 320). At step 1410, the data analyzer 112 in the media co-location system 110 reduces noise of the media data. For example, when the media data is a movie, salt and pepper noise is removed by a median filter. When the media data is an audio, for example, tape hiss is reduced by a single-ended hiss reduction technique. At step 1412, the data analyzer 112 extracts feature value from the media data.

At step 1414, comparing the extracted feature value with typical feature patterns stored in advance which are for example, geometric features of the face of the US President, a voice print of the US President, a waveform of a sound of “America”, etc., the data analyzer 112 detects “Who is speaking”, “What kind of words is he/she speaking”, etc. At step 1416, the data analyzer 112 understands the meaning of the sentences the speaker said using a natural language processing technique. At step 1418, the data analyzer 112 generates some tag/value sets which represent contents of the media data.

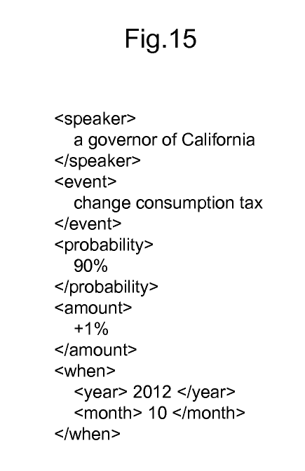

FIG. 15 shows an example of the tag/value sets generated at the step 1418. Words enclosed by “<” (or “</”) and “>” are tags. A tag that begins from “<” is a start tag, while a tag that begins from “</” is an end tag. A portion enclosed by a start tag and an end tag is a value. This kind of tag/value sets are sent from the media co-location system 110 to the order execution system 120 at the step 330 in the form of, for example, XML (eXtensible Markup Language).

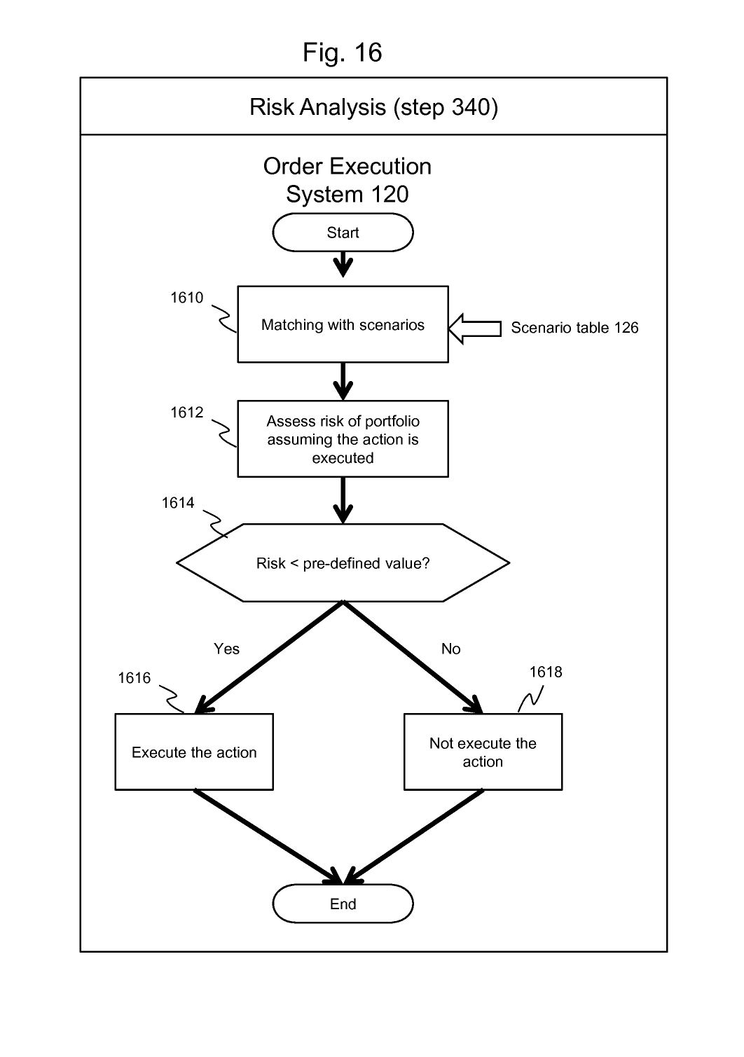

FIG. 16 is a flow diagram showing an example of details of the risk analysis (step 340). At step 1610, the risk analyzer 127 in the order execution system 120 compares tag/value sets sent by media co-location system 110 with pre-defined scenarios stored in the scenario table 126 and detects the same incidents. The scenario table 126 stores various kinds of incidents that have not happened yet and actions the order execution system 120 should take when those incidents happen.

At step 1612, the risk analyzer 127 derives/determines an asset portfolio assuming the action is executed and assesses/calculates the risk of the portfolio. The risk includes, for example, a credit risk, an exchange risk, and a liquidity risk. The risk analyzer 127 decides whether the assessed/calculated risk is below a pre-defined threshold value or not. If the amount of the risk is less than a pre-defined value, at step 1616, the order execution module 123 executes the action detected at the step 1610. Else, at step 1618, the order execution module 123 does not execute the action detected at the step 1610.

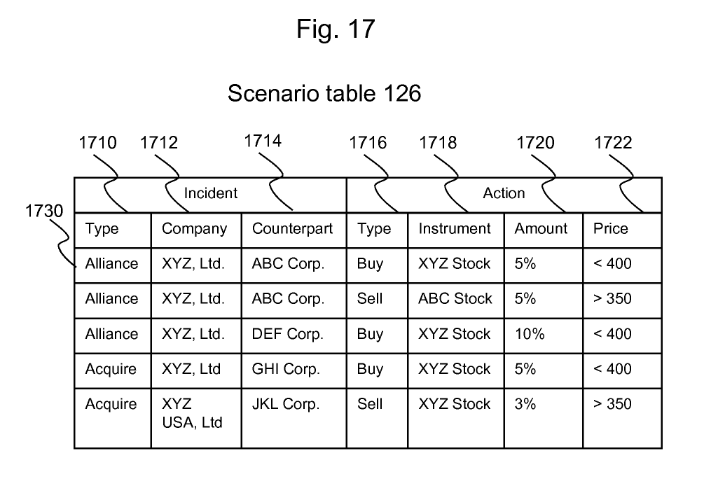

FIG. 17 shows composition of the scenario table 126. The scenario table 126 records the items of a type of incident 1710, a company 1712 that represents a company related directly to the incident, a counterpart 1714 that represents a counterpart of the company 1712, a type of action 1716, a financial instrument 1718 that should be bought/sold as a response to an incident, an amount 1720 that represents a ratio of the amount of the instrument 1718 that should be bought/sold to the current amount of the instrument 1718, and a price 1722 that represents in what range of price the buying/selling action should be taken. For example, row 1730 means “If XYZ, Ltd. arranges an alliance with ABC Corp., buy XYZ stock by 5% of current balance as long as the price of XYZ stock is under 400.”

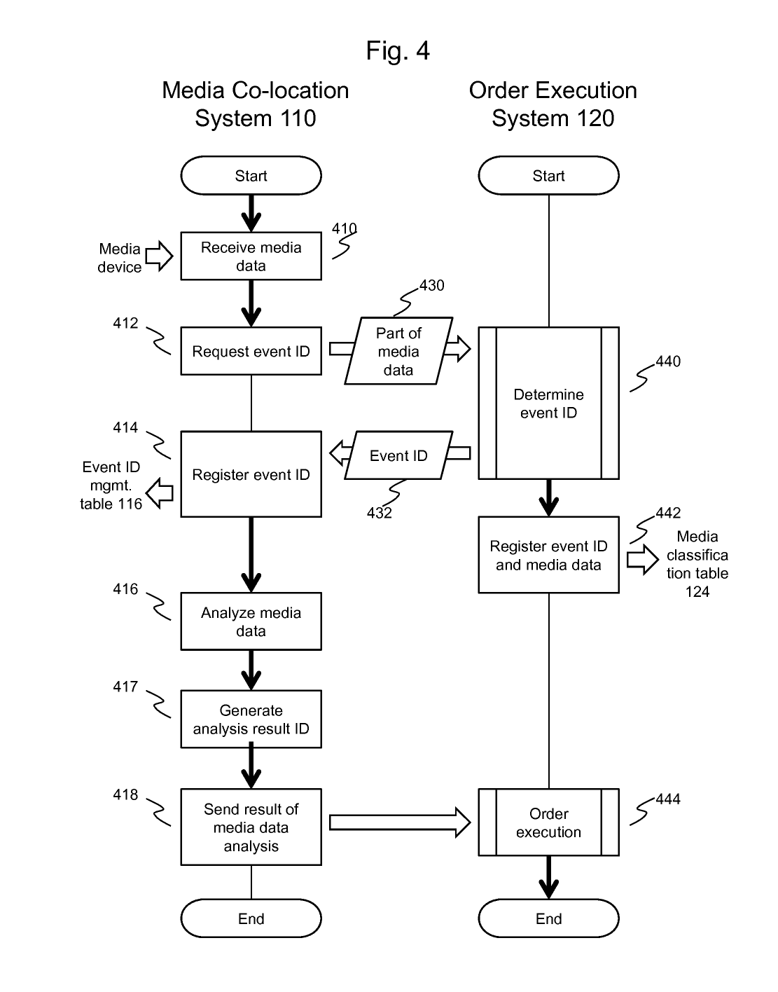

FIG. 4 is a flow diagram showing a method for order execution using rich media analysis in another embodiment. At step 410, the media data receiver 111 in the media co-location system 110 receives media data from the media device 150. At step 412, the event ID request module 114 requests an event ID that will be related to the received media data, sending a part of the media data 430 and its media data ID to the order execution system 120. At step 440, the event ID determination module 121 in the order execution system 120 determines an event ID that will be related to the part of the media data 430 and sends the event ID 432 and the media data ID to the media co-location system 110.

At step 442, the media registration module 122 in the order execution system 120 registers the event ID determined at the step 440, the part of the media data 430 and its media data ID to the media classification table 124. At step 414, the event ID registration module 115 in the media co-location system 110 registers the event ID 432 and the media data ID to the event ID management table 116, making the event ID 432 related to the media data received at step 410. At step 416, the media data is analyzed and a result of the media data analysis, which is for example who is speaking, what he/she is speaking, is derived by the media data analyzer 112 as same as step 320 of the FIG. 3.

At step 417, the media data analyzer 112 generates an analysis result ID. At step 418, the result of the media data analysis, the analysis result ID, and the event ID are sent to the order execution system 120 by analysis output module 113. At step 444, based on the result of the media data analysis, the order execution module 123 in the order execution system 120 executes one or more orders.

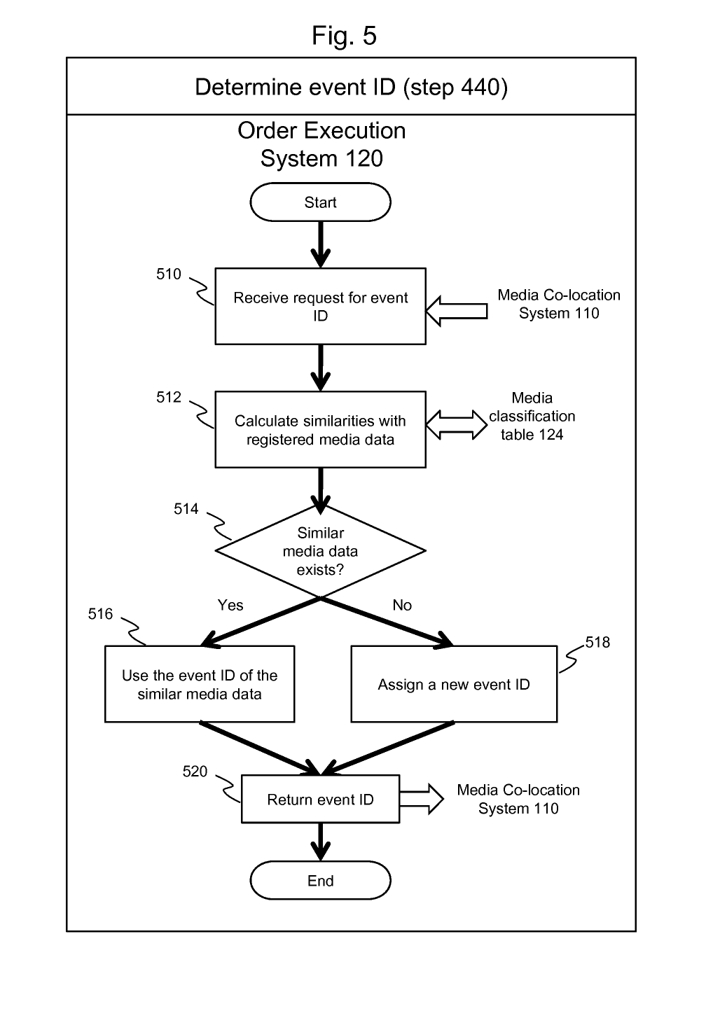

FIG. 5 is a flow diagram showing details of the step 440, determining event ID. At step 510, the order execution system 120 receives a request for an event ID accompanied with the part of media data 430 from the media co-location system 110. At step 512, the event ID determination module 121 calculates similarities between the received part of media data 430 and the other media data registered in the media classification table 124.

The event ID determination module 121 determines a similar media data by referring the calculated similarities. If there are one or more media data that have higher similarities with the received part of the media data 430 than a predefined threshold, an event ID which is the same as the one of a registered media data that has the highest similarity with the received part of the media data 430 is assigned to the received part of the media data 430, therefore those two media data are classified to the same event (step 516).

If there is no media data that have higher similarities with the received part of the media data 430 than a predefined threshold, a new event ID is assigned to the received part of the media data 430 by the event ID determination module 121 (step 518). As step 520, the event ID assigned to the received part of the media data 430 is sent to the media co-location system 110. Note that the step 512, 516 and 518 describe one example of classification method and some of the other traditional classification methods, e.g. furthest neighbor method or group average method, may be applied to this part.

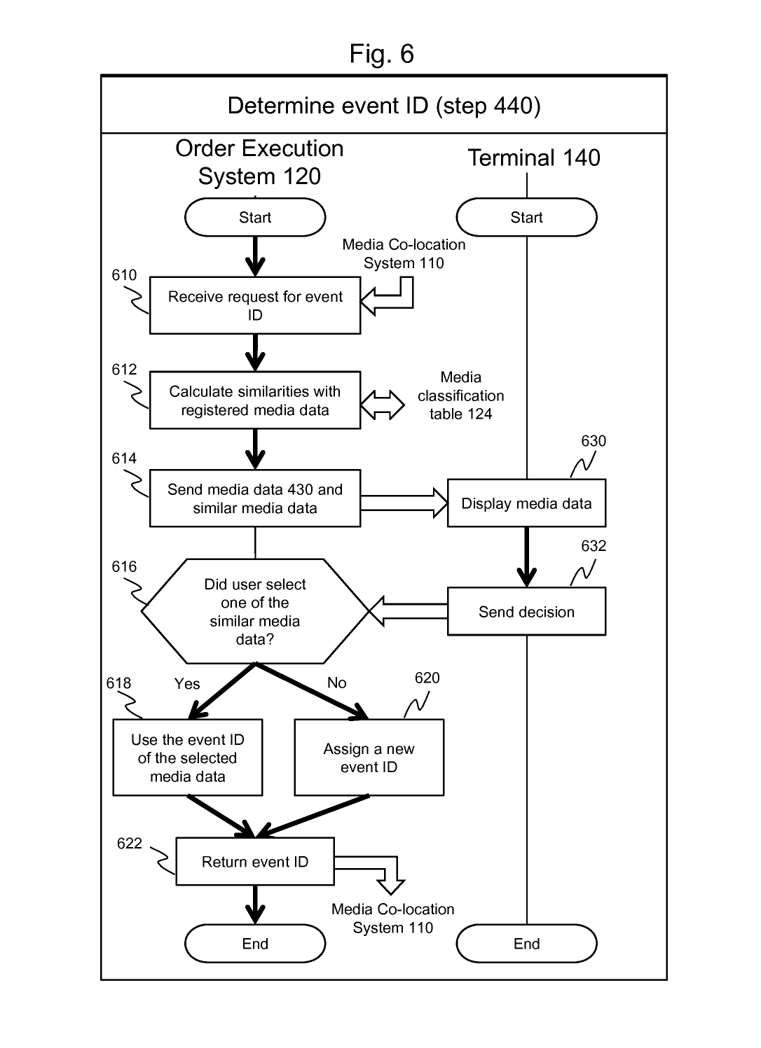

FIG. 6 is a flow diagram showing details of the step 440, determining event ID, in another embodiment. At step 610, the order execution system 120 receives a request for an event ID accompanied with the part of media data 430 from the media co-location system 110. At step 612, the event ID determination module 121 calculates similarities between the received part of media data 430 and the other media data registered in the media classification table 124.

At step 614, the order execution system 120 sends the terminal 140 the part of media data 430 and one or more media data that has higher similarities than a predefined threshold. If there is no media data that has a higher similarity than a predefined threshold, a media data that has the highest similarity and the part of media data 430 are sent to the terminal 140. At step 630, the terminal 140 displays those received media data onto its monitor.

At step 632, the terminal 140 accepts an input of decision made by a user regarding which media data the part of media data 430 should be coupled with, then the decision is sent to the order execution system 120. If the user selected one of the similar media data as a media data expected to be coupled with the part of media data 430, then at step 618, an event ID which is the same as the one of the selected media data is assigned to the part of the media data 430. Else (the user selected “assign a new event ID”), at step 620, a new event ID is assigned to the part of the media data 430. As step 622, the event ID assigned to the part of the media data 430 is sent to the media co-location system 110.

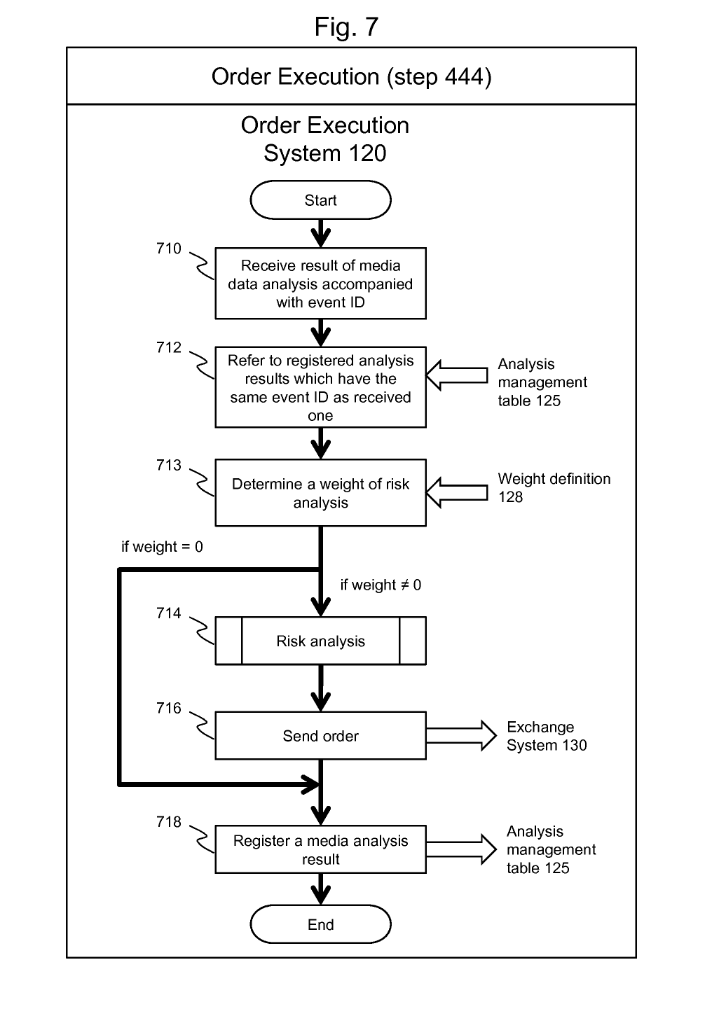

FIG. 7 is a flow diagram showing details of the step 444, order execution. At step 710, the order execution system 120 receives the result of the media data analysis accompanied with the event ID determined at step 440. At step 712, the risk analyzer 127 refers to the analysis management table 125 and looks for analysis results which have the same event ID as the one received in step 710. For example, if there is no analysis result which have the same event ID as the received one, that means the received result is the first media analysis result regarding that event, and any orders regarding that event have not been executed yet.

If there is one analysis result which have the same event ID as the received one, that means the received result is the second media analysis result regarding that event, and one order regarding that event has already been executed. At step 713, the risk analyzer 127 determines a weight of a risk analysis that will be conducted at step 714 based on how many media analysis results which have the same event ID were found at the step 712, referring to the weight definition 128.

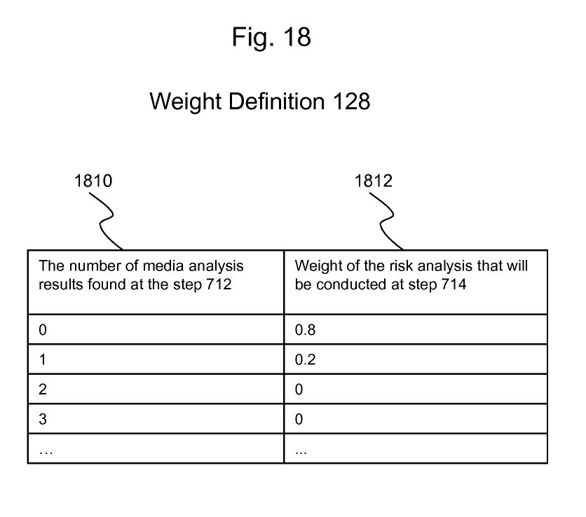

FIG. 18 shows an example of composition of the weight definition 128. The weight definition 128 records relationships between “how many media analysis results which have the same event ID were found at the step 712” (represented as an item 1810 in FIG. 18) and “a weight of the risk analysis that will be conducted at step 714” (represented as an item 1812).

Generally, when the number of media analysis results with the same event ID found at the step 712 is 0, a deal of relatively big amount may be executed because any other deals regarding that event have not executed yet, that results in a relatively larger weight of the risk analysis (which is 0.8 in FIG. 18).

On the other hand, when the number of media analysis results with the same event ID is 1, 2, or more, big deals should not be executed for the purpose of avoiding excessive orders, which results in relatively smaller weights (which are less than 0.2 in FIG. 18).

If the weight determined at the step 713 is 0, the step 714 and the step 716 are skipped because no order needs to be executed in such a case and consequently a risk analysis is not needed. If the weight determined at the step 713 is NOT 0, at step 714, a risk analysis is conducted. The risk analysis at the step 714 is the same as the one at the step 340 which detail is expressed in FIG. 16 except the step 1612. At the step 1612, in this embodiment, the risk analyzer 127 assesses/calculates the risk of portfolio replacing the amount 1720 with a value calculated by multiplying the original amount 1720 by the weight of the risk analysis 1812 determined at the step 713.

For example, if the weight 1812 is 0.8, the scenario table 126 is defined as shown in FIG. 17, and the incident is “XYZ, Ltd. made an alliance with ABC Corp”, then the order execution system 120 conducts a risk analysis assuming that it buys XYZ stock by 4% (=5%×0.8) of its current balance as long as its price is under 400 and sells ABC stock by 4% (=5%×0.8) of its current balance as long as its price is above 350.

At step 716, Bid and/or Ask orders are sent to the exchange system 130 by the order execution module 123. At step 718, the media registration module 122 registers the media analysis result received at the step 710 to the analysis management table 125.

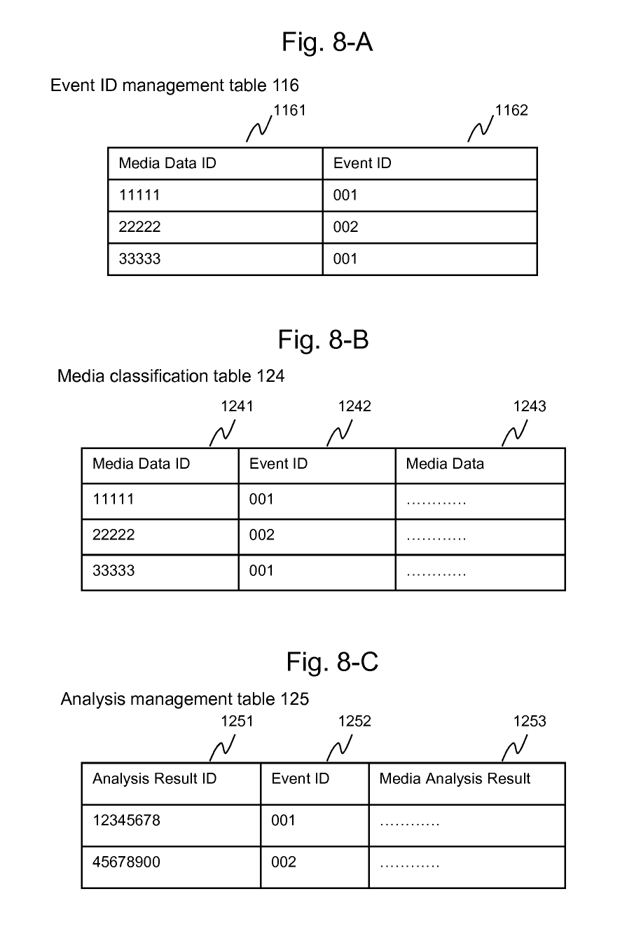

FIG. 8 shows composition of the event ID management table 116, the media classification table 124 and the analysis management table 125. FIG. 8-A is the event ID management table 116, and it records the items of a media data ID 1161 and an event ID 1162 in order to store event ID sent from the order execution system for each media data ID and to SEND event ID and the result of the media data analysis. FIG. 8-B is the media classification table 124, and it records the items of a media data ID 1241, an event ID 1242 and a media data 1243. The media data 1243 stores a part of media data 430 sent from the media co-location system 110. The part of the media data is stored as at least a part of raw data of the media data, or as a hash data generated by hashing from the media data, or link information for the media data. FIG. 8-C is the analysis management table 125 records the items of an analysis result ID 1251, an event ID 1252 and a media analysis result 1253 in order to store the result of the analysis, sent from the media co-location system, for each analysis result ID.

### Embodiment 2

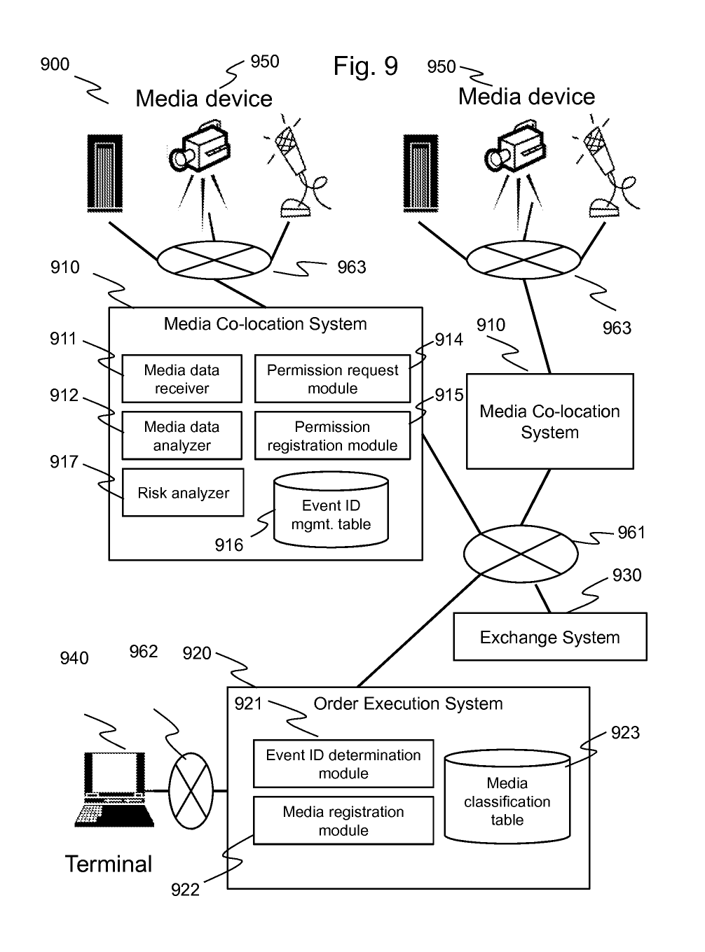

FIG. 9 shows an example of a connection configuration of the trading system 900 in another embodiment. The trading system 900 includes at least one media co-location system 910, a control system 920, an exchange system 930, at least one terminal 940, at least one media device 950. The media co-location system 910, the control system 920 and the exchange system 930 are coupled with a first communication network 961, which is for example a WAN (Wide Area Network), communicatively to each other. The control system 920 and the terminal 940 are coupled with a second communication network 962, which is for example a LAN (Local Area Network), communicatively to each other.

The media co-location system 910 and the media device 950 are coupled with a third communication network 963, which is for example a LAN (Local Area Network), communicatively to each other. The media co-location system 910 includes a media data receiver 911, a media data analyzer 912, an order execution module 913, a permission request module 914, a permission registration module 915, and one or more storage areas for storing a permission management table 916.

The control system 920 includes an event ID determination module 921, a media registration module 922, and one or more storage areas for storing a media classification table 923. The exchange system 930 is a trading platform which receives Bid orders and Ask orders from the media co-location system 910 and matches Bid and Ask orders. The exchange system 930 is owned by, for example, a stock exchange, a commodity exchange, or a futures exchange. The media device 950 is the same as the media device 150.

The media device 950 and the media co-location system 910 are located geographically close to each other so that rich media data may be transferred from the media device 950 to the media co-location system 910 with low latency. A hardware configuration of the media co-location system 910 and the control system 920 is the same as that of the media co-location system 110, which is shown in FIG. 2.

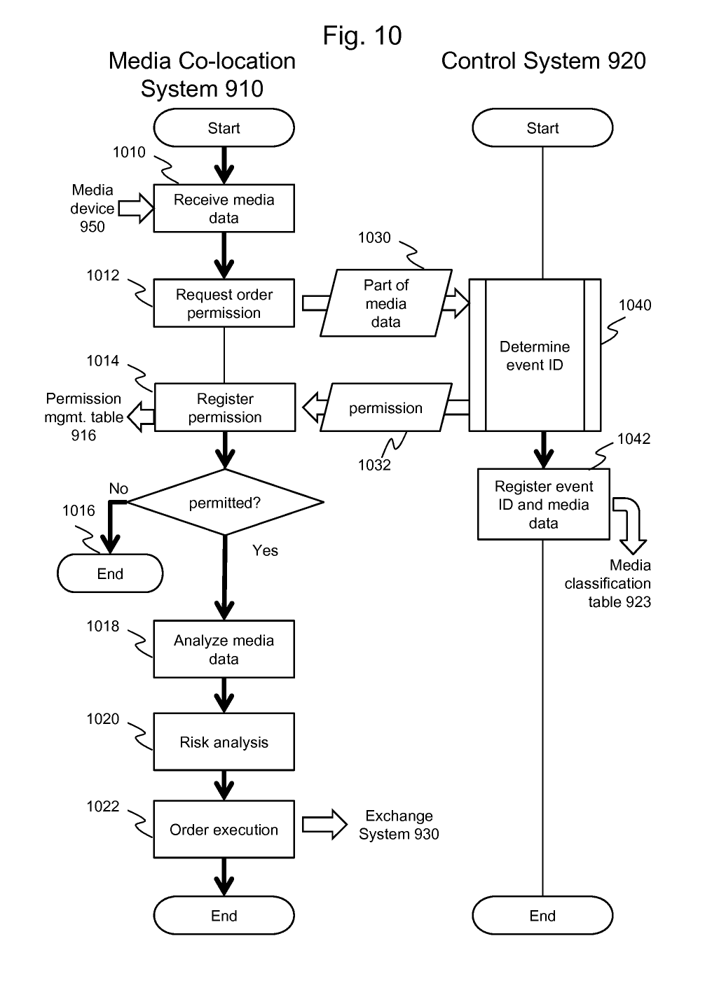

FIG. 10 is a flow diagram showing a method for order execution using rich media analysis. At step 1010, the media data receiver 911 in the media co-location system 910 receives media data from the media device 950. At step 1012, the permission request module 914 requests an order permission regarding the received media data, sending a part of the media data 1030 and its media data ID to the control system 920.

At step 1040, the event ID determination module 921 in the control system 920 determines an event ID that will be related to the part of the media data 1030, makes a decision to permit or not to permit the media co-location system 910 to execute orders, and sends permission information 1032 and the media data ID to the media co-location system 910.

The permission information 1032 contains, for example, either “permitted” or “not permitted”. At step 1042, the media registration module 922 registers the event ID determined at the step 1040, the part of the media data 1030, the media data ID of the media data 1030, and the permission information 1032 to the media classification table 923. At step 1014, the permission registration module 915 in the media co-location system 910 registers the permission information 1032 and the media data ID to the permission management table 916.

If permitted, the media co-location system 910 processes following steps: step 1018, step 1020, and step 1022. At step 1018, the media data is analyzed and a result of the media data analysis, which is for example who is speaking, what he/she is speaking, is derived by the media data analyzer 912. At step 1020, based on the result of the media data analysis, a risk analysis is conducted and results of the risk analysis, which is for example which financial instruments are influenced by the speech, and how strong the influence is, are derived by the risk analyzer 917. At step 1022, Bid and/or Ask orders are sent to the exchange system 930 by the order execution module 913.

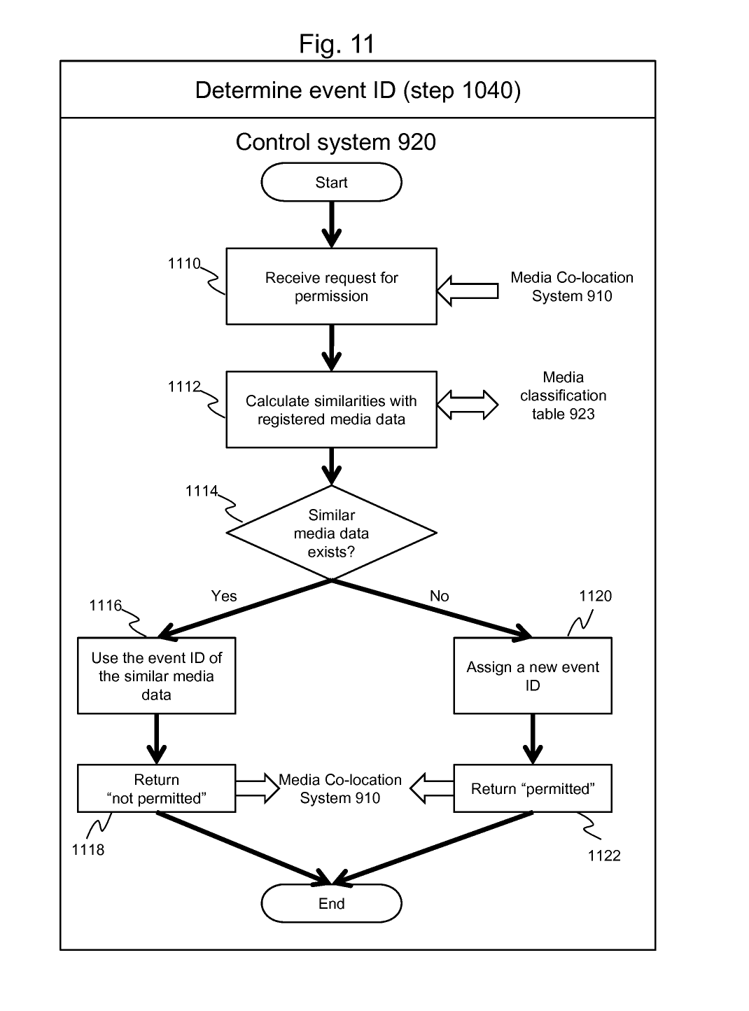

FIG. 11 is a flow diagram showing details of the step 1040, determining event ID. At step 1110, the media data receiver 911 in the control system 920 receives a request for permission accompanied with the part of media data 1030 from the media co-location system 910. At step 1112, the event ID determination module 914 in the control system 920 calculates similarities between the received part of media data 1030 and the other media data registered in the media classification table 923.

The event ID determination module 914 determines a similar media data by referring the calculated similarities. If there are one or more media data that have higher similarities with the received part of the media data 1030 than a predefined threshold, an event ID which is the same as the one of a registered media data that has the highest similarity with the received part of the media data 1030 is assigned to the received part of the media data 1030, therefore those two media data are classified to the same event (step 1116).

And then at step 1118, the event ID determination module 921 in the control system 920 sends permission information of “not permitted” to the media co-location system 910. If there is no media data that have higher similarities with the received part of the media data 1030 than a predefined threshold, a new event ID is assigned to the received part of the media data 1030 (step 1120).

And then at step 1122, the event ID determination module 921 in the control system 920 sends permission information of “permitted” to the media co-location system 910. Note that the step 1112, 1116 and 1120 describe one example of classification method and some of the other traditional classification methods, e.g. furthest neighbor method or group average method, may be applied to this part.

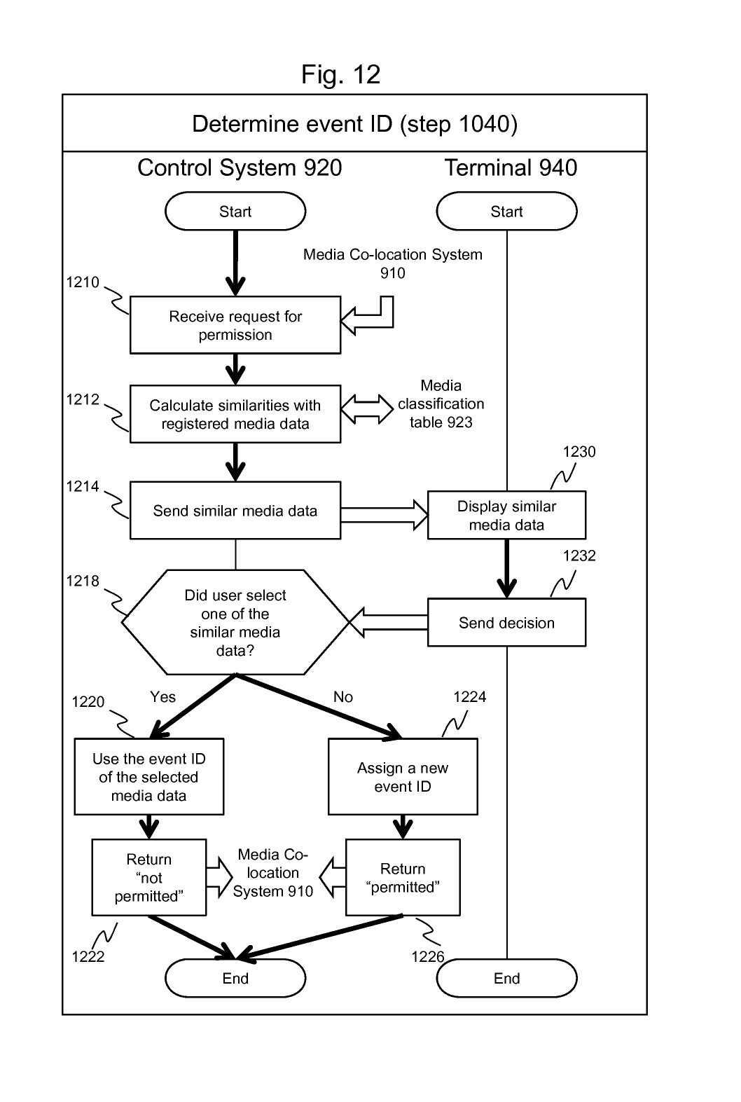

FIG. 12 is a flow diagram showing details of the step 1140, determining event ID, in another embodiment. At step 1210, the control system 920 receives a request for permission accompanied with the part of media data 1030 from the media co-location system 910. At step 1212, the event ID determination module 921 in the control system 920 calculates similarities between the received part of media data 1030 and the other media data registered in the media classification table 923.

At step 1214, the event ID determination module 921 sends the terminal 940 the part of media data 1030 and one or more media data that has higher similarities than a predefined threshold. If there is no media data that has a higher similarity than a predefined threshold, a media data that has the highest similarity and the part of media data 1030 are sent to the terminal 940 by event ID determination module 921. At step 1230, the terminal 940 displays those received media data onto its monitor.

At step 1232, the terminal 940 accepts an input of decision made by a user regarding which media data the part of media data 1030 should be coupled with, then the decision is sent to the control system 920. If the user selected one of the similar media data as a media data expected to be coupled with the part of media data 1030, then at step 1220, an event ID which is the same as the one of the selected media data is assigned to the part of the media data 1030 by the event ID determination module 921.

Then at step 1222, permission information of “not permitted” is sent to the media co-location system 910 by the event ID determination module 921. Else (the user selected “assign a new event ID”), at step 1224, a new event ID is assigned to the part of the media data 1030. Then at step 1226, permission information of “permitted” is sent to the media co-location system 910 by the event ID determination module 921.

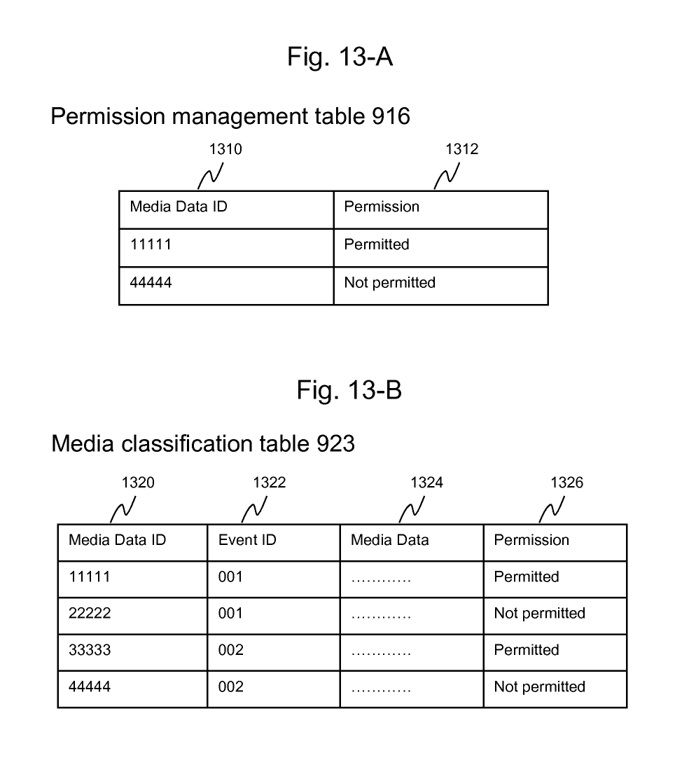

FIG. 13 shows composition of the permission management table 916 and the media classification table 923. FIG. 13-A is the permission management table 916, and it records the items of a media data ID 1310 and a permission 1312. FIG. 13-B is the media classification table 923, and it records the items of a media data ID 1320, an event ID 1322, a media data 1324, and a permission 1326 in order to store a part of the media data sent from the media co-location system and the event ID allocated to the part of the media data.

1. A trading computer system comprising:
(1) a media co-location system including:
(1-1) a media data receiver configured to receive media data;
(1-2) a media data analyzer configured to analyze the media data and generates a value set by comparing a feature value extracted from the media data with a pre-stored feature patterns;
(1-3) an analysis output module send the value set to an order execution system as a result of the analysis;
(2) the order execution system including:
(2-1) a risk analyzer configured to determine an asset portfolio by comparing the value set in the result of analysis sent from the analysis output module with pre-defined incident scenarios stored in the scenario information, and to analyze a risk of an order by calculating a risk of the asset portfolio and comparing the calculated risk of the asset portfolio with a pre-defined threshold value;
(2-2) an order execution module configured to execute Bit or Ask order if the risk of the asset portfolio is less than a pre-defined value.

2. The trading computer system according to claim 1, wherein the media co-location system further including:
(1-4) an event ID request module configured to send a request of an event ID with a part of the media data extracted from the media data;
wherein the order execution system further including:
(2-3) an event ID determination module configured to send the event ID relating to the part of the media data to the media co-location system;
wherein the risk analyzer receives the result of analysis with the event ID and calculates the risk of the asset portfolio by considering the event ID.

3. The trading computer system according to claim 2, wherein the event ID determination module determines the event ID relating to the part of the media data by calculating a similarity between the part of media received from the event ID request module and media data stored in the media classification information, and determining the event ID which is a same as one of the stored media data that has the highest similarity with the part of the media data.

4. The trading computer system according to claim 3, wherein the risk analyzer calculates a weight of the result of analysis based on the number of the result of analysis for each event ID and analyzes the risk of an order by calculating a risk of the asset portfolio according to the weight of the result of analysis.

5. The trading computer system according to claim 4, wherein the weight of the result of analysis in which the number of the result of analysis is 0 is less than the weight of the result of analysis in which the number of result of analysis is bigger than 0.

6. A media co-location system comprising:
(1-1) a media data receiver configured to receive media data;
(1-2) a permission request module configured to send a request of a permission information with a part of the media data extracted from the media data;
(1-3) a permission registration module configured to receive a permission information relating to the part of the media data, wherein the permission information is determined by an event ID determination module;
(1-4) a media data analyzer configured to analyze the media data and generates a value set by comparing a feature value extracted from the media data with a pre-stored feature patterns if the permission information indicates “permitted”;
(1-5) a risk analyzer configured to determine an asset portfolio by comparing the value set in the result of analysis with pre-defined incident scenarios stored in the scenario information, and to analyze a risk of an order by calculating a risk of the asset portfolio and comparing the calculated risk of the asset portfolio with a pre-defined threshold value;
(1-6) an order execution module configured to execute Bit or Ask order if the risk of the asset portfolio is less than a pre-defined value.

7. The media co-location system according to claim 6, wherein the event ID determination module determines the event ID relating to the part of the media data by calculating a similarity between the part of media received from the event ID request module and media data stored in the media classification information, and determining the event ID which is a same as one of the stored media data that has the highest similarity with the part of the media data if the calculated similarity is higher than a pre-sat threshold.

8. The media co-location system according to claim 7, wherein the event ID determination module determines the event ID relating to the part of the media data by assigning a new event ID if the calculated similarity is less than a pre-sat threshold.

9. The media co-location system according to claim 8, wherein the event ID determination module sends the permission information indicating “not-permitted” if the calculated similarity is higher than a pre-sat threshold and sends the permission information indicating “permitted” if the calculated similarity is less than a pre-sat threshold.

10. A computing method for trading computer system comprising the steps of:
(1-1) receiving media data;
(1-2) analyzing the media data and generating a value set by comparing a feature value extracted from the media data with a pre-stored feature patterns;
(1-3) sending the value set to an order execution system as a result of the analysis;
(1-4) determining an asset portfolio by comparing the value set in the result of analysis with pre-defined incident scenarios stored in the scenario information, analyzing a risk of an order by calculating a risk of the asset portfolio, and comparing the calculated risk of the asset portfolio with a pre-defined threshold value;
(1-5) executing Bit or Ask order if the risk of the asset portfolio is less than a pre-defined value.

11. The computing method for trading computer system according to claim 10, further comprising the steps of:
(1-1-1) sending a request of an event ID with a part of the media data extracted from the media data;
(1-1-2) sending the event ID relating to the part of the media data;
wherein the risk of the asset portfolio is calculated by considering the event ID.

12. The computing method for trading computer system according to claim 11,
wherein the event ID relating to the part of the media data id determined by calculating a similarity between the part of media and media data stored in the media classification information, and determining the event ID which is a same as one of the stored media data that has the highest similarity with the part of the media data.

13. The computing method for trading computer system according to claim 12,
wherein a weight of the result of analysis is calculated based on the number of the result of analysis for each event ID and the risk of an order is analyzed by calculating a risk of the asset portfolio according to the weight of the result of analysis.

14. The computing method for trading computer system according to claim 11,
wherein the weight of the result of analysis in which the number of the result of analysis is 0 is less than the weight of the result of analysis in which the number of result of analysis is bigger than 0.

15. A computing method for media co-location system comprising the steps of:
(1-1) receiving media data;
(1-2) sending a request of permission information with a part of the media data extracted from the media data;
(1-3) receiving a permission information relating to the part of the media data, wherein the permission information is determined by an event ID determination module;
(1-4) analyzing the media data and generating a value set by comparing a feature value extracted from the media data with a pre-stored feature patterns if the permission information indicates “permitted”;
(1-5) determining an asset portfolio by comparing the value set in the result of analysis with pre-defined incident scenarios stored in the scenario information, and analyzing a risk of an order by calculating a risk of the asset portfolio and comparing the calculated risk of the asset portfolio with a pre-defined threshold value;
(1-6) executing Bit or Ask order if the risk of the asset portfolio is less than a pre-defined value.

16. The computing method for media co-location system according to claim 15,
wherein the event ID relating to the part of the media data is determined by calculating a similarity between the part of media received from the event ID request module and media data stored in the media classification information, and determining the event ID which is a same as one of the stored media data that has the highest similarity with the part of the media data if the calculated similarity is higher than a pre-sat threshold.

17. The computing method for media co-location system according to claim 16,
wherein the event ID relating to the part of the media data is determined by assigning a new event ID if the calculated similarity is less than a pre-sat threshold.

18. The computing method for media co-location system according to claim 17,
wherein sending the permission information indicating “not-permitted” if the calculated similarity is higher than a pre-sat threshold and sends the permission information indicating “permitted” if the calculated similarity is less than a pre-sat threshold.
